(19) United States
(12) Patent Application Publication
(10) Pub. No.: US 2008/0045278 A1
(43) Pub. Date: Feb. 21, 2008

(54) Externally connected glucometer for a communication device

(75) Inventor: Steven Kim, Harrington Park, NJ (US)

Correspondence Address: SEYFARTH SHAW, LLP, 815 CONNECTICUT AVENUE, N.W., SUITE 500, WASHINGTON, DC, 20006, US

(73) Assignee: Healthpia America Corp., Palisades Park, NJ (US)

(21) Appl. No.: 11/505,884

(22) Filed: Aug. 18, 2006

(51) Int. Cl. H04M 1/00

(52) U.S. Cl. 455/575.1

(57) ABSTRACT

A measurement apparatus for a communication device includes a body with a measuring unit and a penetrable slit, the body extending in a first direction; a flange protruding from the body; and a connector protruding in the first direction from the flange for outputting a measurement data.

### BACKGROUND OF THE INVENTION

1. Field of the Invention

The present invention relates to a glucometer, and more particularly, to an externally connected glucometer for a personal communication device. Although the present invention is suitable for a wide scope of applications, it is particularly suitable as an add-on device for a mobile phone.

2. Discussion of the Related Art

In general, personal communication devices are becoming more and more versatile. They provide many useful features in addition to basic point-to-point communication. For example, current personal communication devices, such as mobile phones, personal digital assistants, handheld, palmtop and pocket computers allow users to access the internet, send and receive text messaging, and stream data into and out of the personal communication device.

The availability of such an array of features enables the development of new services to increase the usefulness of those personal communication devices. For example, healthcare providers and patients can benefit from those value-added services by allowing more ubiquitous multimodal communications between patients and healthcare providers. In particular, patients can enjoy greater mobility with the availability of remote monitoring by healthcare providers, and on-demand transmissions of health-related measurement data from the patients to their healthcare providers.

FIG. 1a is a side view of a personal communication device according to the related art. FIG. 1b is a top view of the related art personal communication device of FIG. 1a. FIG. 1c is a bottom view of the related art personal communication device of FIG. 1a. Referring to FIGS. 1a-1c, the personal communication device is a flip-up mobile phone 1. The mobile phone 1 includes a body 10, a back cover 13, and a flipping cover 12. The body 10 incorporates a keypad (not shown) for alphanumeric entry. The user can, for example, use the alphanumeric keypad for entering text messages for sending to a healthcare provider.

The flipping cover 12 incorporates a liquid crystal display (LCD) (not shown). The LCD display can be used to display information for the user. For example, when the user is entering an alphanumeric data using the keypad, the LCD can be used to display the message being entered by the user. Also, when messages are received from a healthcare provider, the user can view the messages on the LCD screen.

Currently, nearly all mobile phone devices include a rechargeable battery to increase mobility. The rechargeable battery powers the phone and keeps the phone operational for an extended period of time. Some batteries can keep a phone on in a stand-by mode for several days. A phone can be communicating for several hours before completely draining the battery. In the related art mobile phone of FIG. 1c, the battery can be recharged by placing the mobile phone on a stand that provide connectors in a matching relationship with the connection terminals 15 of the mobile phone 1.

The mobile phone 1 can also be provided with a communication port 14. The communication port 14 can be, for example, a serial communication port for communication with a serial communication device, such as a computer, or a measurement device. A commonly used serial communication port is the universal serial bus (USB). A USB port allows fast bi-directional communication between a mobile phone and an external device. The mobile phone 1 can also communicate with an external device using a wireless connection. Bluetooth is an example of wireless connection for communication between a mobile phone and a nearby device.

FIG. 1d is a top view of an external glucometer being attached to a mobile phone in accordance with the related art. Referring to FIG. 1d, an external glucometer 2 includes a measuring unit 20 for measuring a glucose level. A slit 32 is provided on a side of the external glucometer 2. A measuring strip 30 is insertable into the slit 32. When the measuring strip 30 is impregnated with a body fluid, for example, a drop of blood, the external glucometer 2 can measure the glucose level in the fluid.

A connector 22 is provided at another side of the external glucometer 2. The connector 22, for example, is a USB connector, that can be inserted into the communication port 14 of the mobile phone 1. The external glucometer 2 can be powered through the USB port. Moreover, measurement data from the glucometer 2 can be downloaded to the mobile phone 1 such that a user can read the measurement and/or for communication to a health care provider.

The related art external glucometer 2 dangles and hangs out from the side of the mobile phone 1. Thus, the related art glucometer 2 is only attached via the USB port and can easily fall of the phone. Moreover, the related art glucometer 2 can be cumbersome, discouraging the user from using it, therefore, reducing use of the glucometer.

### SUMMARY OF THE INVENTION

Accordingly, the present invention is directed to an externally connected glucometer for a personal communication device that substantially obviates one or more of the problems due to limitations and disadvantages of the related art.

An object of the present invention is to provide an external glucometer securely and reliably attached to a personal communication device to enable ease of use.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a measurement apparatus for a communication device includes a body with a measuring unit and a penetrable slit, the body extending in a first direction; a flange protruding from the body; and a connector protruding in the first direction from the flange for outputting a measurement data.

In another aspect, a measurement apparatus for a communication device includes a body with a measuring unit and a penetrable slit; a flange protruding from the body; a connector protruding from the flange for outputting a measurement data; and a retainer removably attached to the body.

In another aspect, a measurement apparatus for a communication device includes a body with a measuring unit and a penetrable slit at a first end thereof; a first flange protruding from the first end of the body; a second flange attached to an hinge at a second end of the body; and a connector protruding from the second flange for outputting a measurement data.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1a is a side view of personal communication device according to a related art.

FIG. 1b is a top view of the related art personal communication device shown in FIG. 1a.

FIG. 1c is a bottom view of the related art personal communication device shown in FIG. 1a.

FIG. 1d is a top view of an external glucometer being attached to a mobile phone in accordance with the related art.

FIG. 2a is a side view of an exemplary external glucometer in accordance with a first embodiment of the present invention.

FIG. 2b is a top view of the external glucometer shown in FIG. 2a.

FIGS. 2c-2d show exemplary steps for affixing the external glucometer shown in FIGS. 2a and 2b to a communication device.

FIG. 3a is a side view of an exemplary retaining member for holding a communication device against an external glucometer, in accordance with a second embodiment of the present invention.

FIG. 3b is a front view of an interior surface of the exemplary retaining member shown in FIG. 3a.

FIG. 3c is a top view of the exemplary retaining member shown in FIG. 3a.

FIGS. 4a-4c show exemplary steps for affixing the external glucometer shown in FIGS. 2a and 2b to a communication device using the retaining member shown in FIGS. 3a and 3c.

FIG. 5a is a first side view of an exemplary external glucometer affixed to the mobile phone shown in FIG. 4c.

FIG. 5b is a second side view of the exemplary external glucometer affixed to the mobile phone shown in FIG. 4c.

FIG. 5c is a bottom view of the exemplary external glucometer affixed to the mobile phone shown in FIG. 4c.

FIG. 5d is a top view of the exemplary external glucometer affixed to the mobile phone as shown in FIG. 4c.

FIG. 6a is a front view of an exterior surface of an exemplary retaining member for holding a communication device against an external glucometer, in accordance with a third embodiment of the present invention.

FIG. 6b is a top view of the exemplary retaining member shown in FIG. 6a.

FIG. 7a is a side view of an exemplary external glucometer affixed to a mobile phone using the retaining member shown in FIGS. 6a-6b.

FIG. 7b is a top view of the exemplary external glucometer affixed to the mobile phone shown in FIG. 7a.

FIG. 8a is a top view of an exemplary external glucometer in accordance with a fourth embodiment of the present invention.

FIG. 8b is a top view of the exemplary external glucometer of FIG. 8a affixed to a mobile phone.

FIG. 9 is a side view of an exemplary external glucometer in accordance with a fifth embodiment of the present invention.

FIGS. 10a and 10b show exemplary steps for affixing the external glucometer shown in FIG. 9 to a communication device.

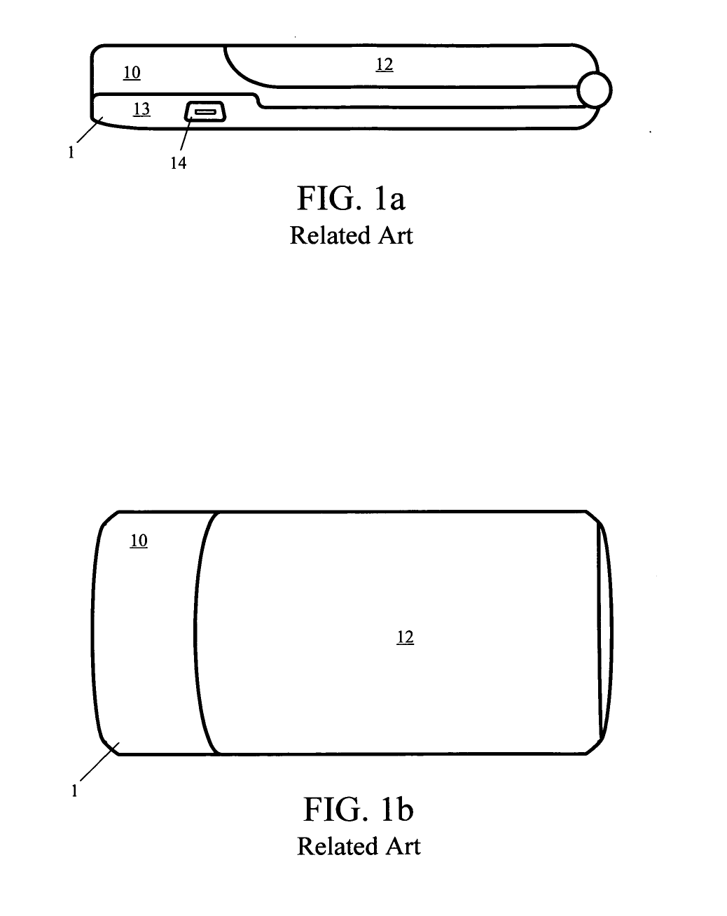

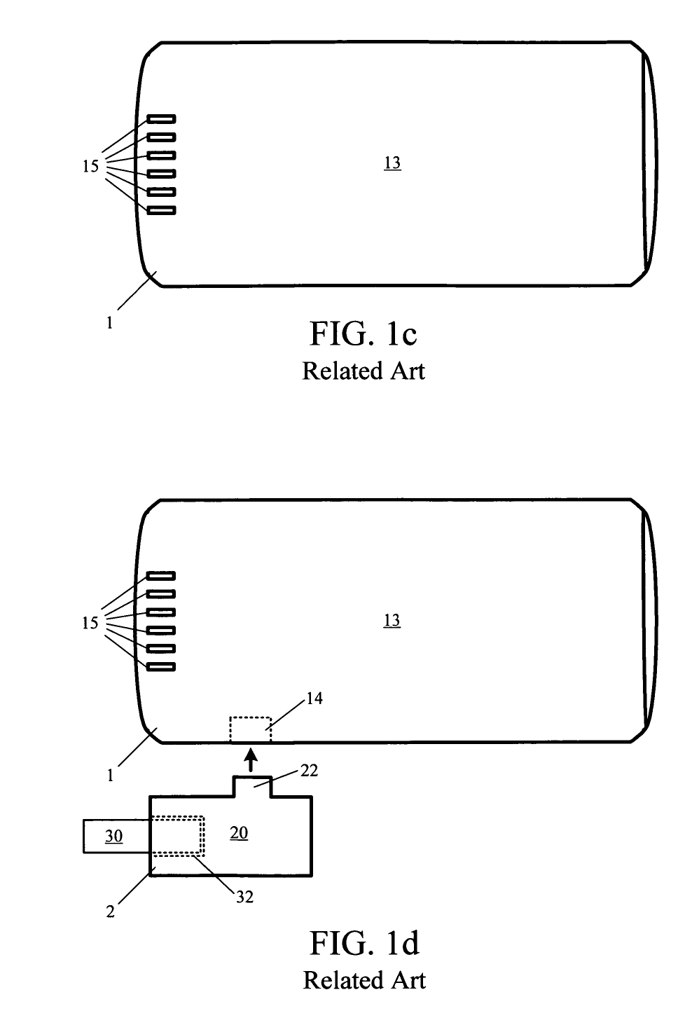

### DETAILED DESCRIPTION OF THE PREFERRED EMBODIMENTS

Reference will now be made in detail to the preferred embodiments of the present invention, examples of which are illustrated in the accompanying drawings.

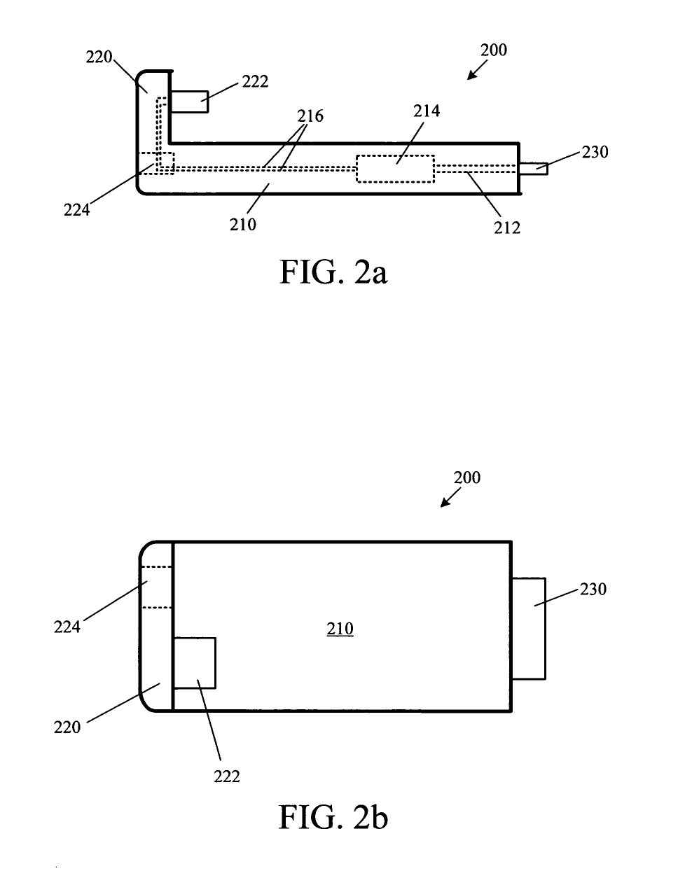

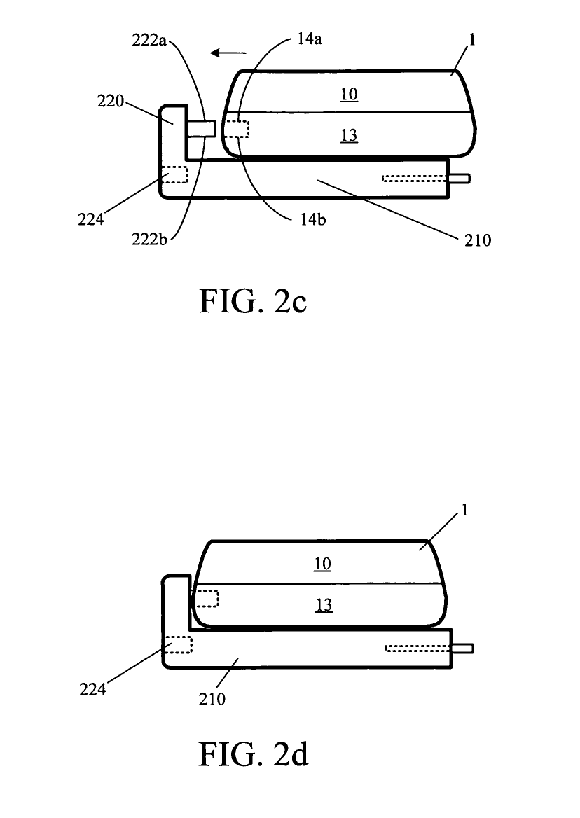

FIG. 2a is a side view of an exemplary external glucometer in accordance with a first embodiment of the present invention. FIG. 2b is a top view of the external glucometer shown in FIG. 2a. Referring to FIGS. 2a-2b, a glucometer 200 for measuring a glucose level includes a body 210 and a flange 220 protruding from the body 210. As shown in FIG. 2a, the flange 220 can be integrally formed with the body 210. As shown in FIG. 2b, the flange 220 also can be a separate unit fixedly attached to the body 210. For example, the flange 220 can be screwed onto the body 210. In another alternative, the flange 220 can also be glued to the body 210.

A slot 212 is provided at a first end of the body 210. The slot 212 is wide enough for inserting a measuring strip 230, such as a glucose test strip, into the body 210. The measuring strip 230 can be impregnated with a specimen (not shown), for example, a drop of blood, the glucose level of which is to be measured.

The body 210 of the glucometer 200 incorporates a measuring unit 214 for measuring a glucose level in a specimen. The measuring unit 214 provides glucose measuring capability to the body 210. For example, when the measuring strip 230 is impregnated with a specimen, such as blood, and inserted into the slit 212, the measuring unit 214 can analyze the specimen and detect the level of glucose in the specimen.

A connector 222 protrudes from the flange 220. The protruding connector 222 is positioned on an interior surface of the flange 220 such that the connector 222 extends in the same direction as the body 210. The protruding connector 222 is linked to the measuring unit 214. The link 216 between the connector 222 and the measuring unit 214 can be, for example, a wire electrically connecting the connector 222 to the measuring unit 214. The link 216 can also be a communication bus, for example, a serial communication bus, such as a Universal Serial Bus (USB) for communication with an external USB device. In another alternative, the link 216 can be a wireless link. For example, the link 216 can provide a Bluetooth connection between the glucometer and an external communication device.

The connector 222 provides communication capabilities from the glucometer 200. For example, the glucometer 200 can output a measurement data from the measuring unit 214 to a communication device (not shown). Data can also be inputted to the glucometer 200 through the connector 222. Such input data can be, for example, initialization data for setting the glucometer, calibration data for calibrating the measuring unit 214, scheduling data for specifying a schedule for the measurements. Further, power can be provided to the glucometer through the connector 222.

A communication port 224 can also be provided on an outside surface of the flange 220. The communication port 224 can be, for example, a USB slot for attaching an external USB device to the glucometer. The communication port 224 can also be a wireless port, such as infrared to establish a connection between the glucometer and an external communication device.

FIGS. 2c-2d show exemplary steps for affixing the external glucometer shown in FIGS. 2a and 2b to a communication device. Referring to FIG. 2c, a communication device, such as a mobile phone 1, is positioned on an interior surface of the body 210. As shown, the body 210 of the glucometer 200 is on a rear surface of the mobile phone 1. A communication slot 14 of the mobile phone 1 faces the connector 222 on the interior surface of the flange 220.

Then, as shown in FIG. 2d, the mobile phone 1 is laterally slid toward the flange 220 of the glucometer 200 until the connector 222 is inserted into the communication slot 14 of the mobile phone 1. The side of the mobile phone 1 where the communication slot 14 is located may contact the interior side of the flange 220. At the end of the sliding motion, the connector 222 is coupled with the communication slot 14 of the mobile phone 1.

In an embodiment of the present invention, the connector 222 may be configured in such a manner as to provide friction between surfaces 222a and 222b of the connector 222 with contact surfaces 14a and 14b of the communication slot 14. The friction exerted between the surfaces 222a and 222b of the connector 222 and the contact surfaces 14a and 14b of the communication slot 14 can be strong enough to hold the glucometer against the communication device. The friction between the contact surfaces 222a and 14a, and 222b and 14b, respectively, also maintains good electrical contact between the connector 222 and the communication slot 14 for reliable transmission of communication signals between the mobile phone 1 and the glucometer 200.

In accordance with an embodiment of the present invention as described above, the glucometer 200 is held against the mobile phone 1 by a combination of the body 210, the flange 220 and the connector 222. As depicted in FIGS. 2a, 2c and 2d, the connector 222 protrudes from the flange 220, which protrudes from the body 210. Thus, when the connector 222 is inserted into the communication slot 14 of the mobile phone 1, the combination of the body 210, the flange 220 and the connector 222 functions as a hook for holding the glucometer against the mobile phone 1 while in use. Moreover, the friction exerted between contact surfaces 222a and 222b of the connector 222 with the contact surfaces 14a and 14b, respectively, of the communication slot 14 functions to hold the glucometer 200 to the mobile phone 1.

However, referring to FIG. 2d, in spite of the holding capability performed by the combination of the body 210, the flange 220 and the connector 222, a lateral impact on the side of the flange 220 may cause the mobile phone 1 to be dislodged from its contact position against the flange 220. If the lateral impact is strong enough, the motion of the mobile phone 1 away from the flange 220 may cause the connector 222 to be disengaged from the communication slot 14. To avoid such an occurrence, a retainer may be provided to hold the mobile phone 1 tightly against the flange 220.

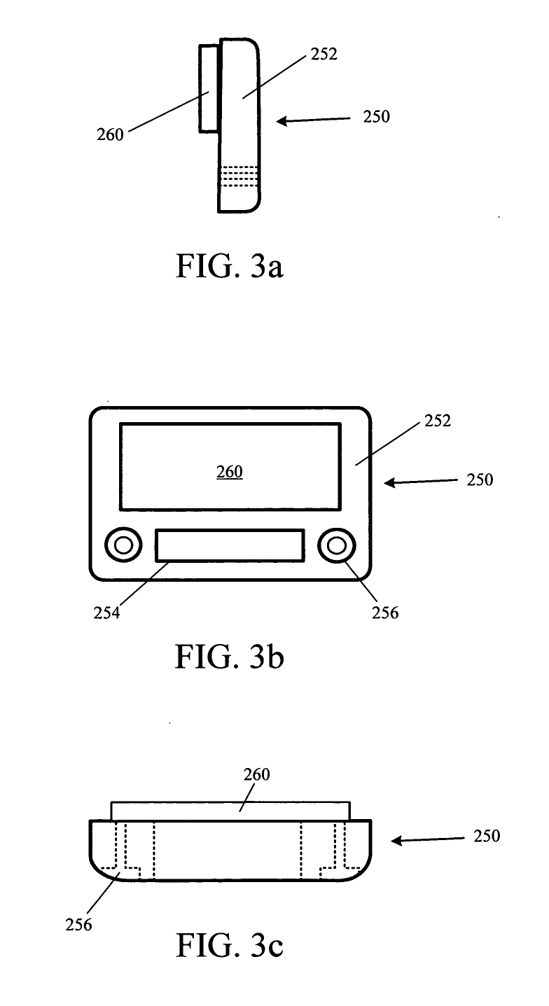

FIG. 3a is a side view of an exemplary retaining member for holding a communication device against an external glucometer, in accordance with another embodiment of the present invention. FIG. 3b is a front view of an interior surface of the exemplary retaining member of FIG. 3a. FIG. 3c is a top view of the exemplary retaining member of FIG. 3a. Referring to FIGS. 3a-3c, a retaining member 250 includes a retainer 252 and a springy material 260 provided on an inside surface of the retainer 252. The retainer 252 may include fixing holes 256 for attaching the retainer member 250 to the body of an external glucometer. An opening 254 is provided through the retainer 250. The opening 252 is penetrable by a measuring strip, such as the measuring strip 230 shown in FIG. 2a. In an embodiment, the fixing holes 256 and the opening 254 can be provided at a lower portion of the retainer 252. The springy material 260 can be provided at an upper portion of the retainer 252, and the opening can be provided at a lower portion of the retainer 252.

The springy material 260 is compressible. As such, the springy material 260 is capable of being deformed when compressed, for example, when pressed against the surface of a solid object by the retainer 252. The springy material 260 is also elastic. As such, the springy material 260 is capable of nearly resuming its original shape when released from a compressed state. Moreover, the springy material 260 tends to resist the compressing force, trying to maintain its original shape.

The springy material 260 can be, for example, a spring. The springy material 260 can also be made of a sponge-like material, such as a porous plastic or rubber material. Further, the springy material 260 can be made of a foamy rubber, a light firm spongy rubber. In general, the springy material 260 can be made of any porous semirigid material also useable for shock absorption. The springy material 260 can be used to fasten a mobile phone to the glucometer by holding the mobile phone between the flange of the glucometer and the retaining member.

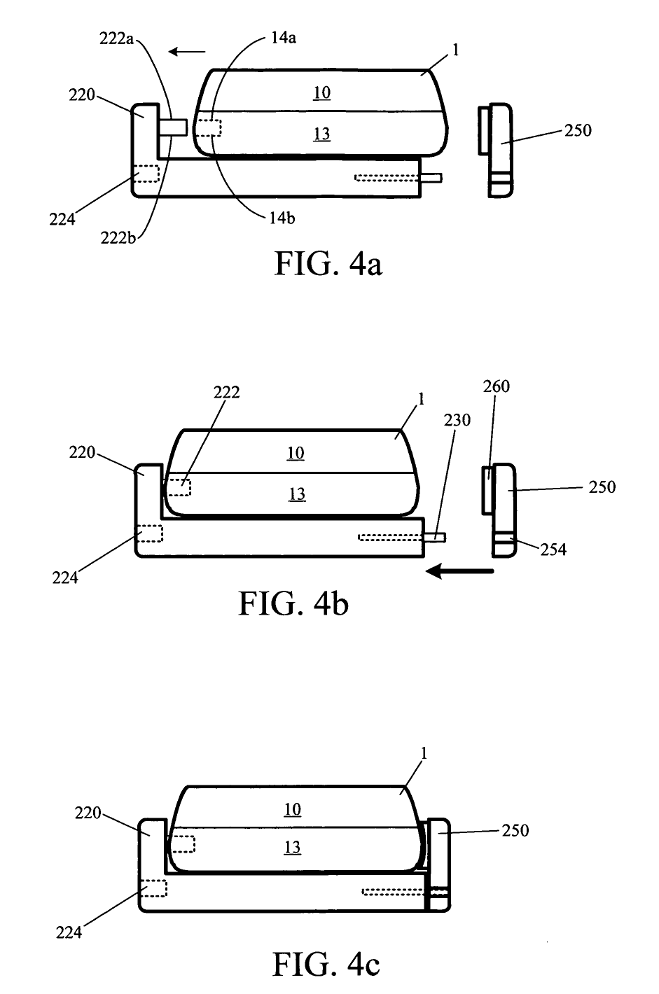

FIGS. 4a-4c show exemplary steps for affixing the external glucometer shown in FIGS. 2a and 2b to a communication device using the retaining member shown in FIGS. 3a and 3c. Referring to FIG. 4a, a mobile phone 1, is positioned on an interior surface of the body 210. As shown, the body 210 of the glucometer 200 is on a rear surface of the mobile phone 1. A communication slot 14 of the mobile phone 1 faces the connector 222 on the interior surface of the flange 220.

Then, as shown in FIG. 4b, the mobile phone 1 is laterally slid toward the flange 220 of the glucometer until the connector 220 is inserted into the communication slot 14 of the mobile phone 1. The side of the mobile phone 1 where the communication slot 14 is located may contact the interior side of the flange 220. At the end of the sliding motion, the connector 220 is coupled with the communication slot 14 of the mobile phone. Then, the retaining member 250 is positioned such that the opening 254 faces the slit 212.

Then, as shown in FIG. 4c, the retaining member 250 is moved toward the slit side of the body 210 of the glucometer 200, and the mobile phone 1 held thereon, until the connector 220 is inserted into the communication slot 14 of the mobile phone 1. As such, the opening 254 through the retainer 252 is in a matching correspondence with the slit 212 on the measuring unit 210, so that the retainer 252 and the slit 212 are jointly penetrable with the strip 230. The side of the mobile phone 1 where the communication slot 14 is located may contact the interior side of the flange 220. At the end of the sliding motion, the connector 220 is coupled with the communication slot 14 of the mobile phone.

The springy material 260 holds the mobile phone 1 between the flange 220 of the glucometer 200 and the retaining member 250. When the springy material 260 is compressed between a the mobile phone 1 and the retainer 252, the springy material 260 will exert a force on the contacting surface of mobile phone 1 and an opposite force on the contacting surface of the retainer 252. Accordingly, the springy material 260 will hold the mobile phone 1 in position. Thus, the mobile phone 1 remains attached to the body 210 of the glucometer 200, between the flange 220 and the retaining member 250.

In an embodiment, the connector 222 may be dimensioned in such a manner as to provide friction between surfaces 222a and 222b of the connector 222 with contact surfaces 14a and 14b of the communication slot 14. The friction exerted between the surfaces 222a and 222b of the connector 222 and the contact surfaces 14a and 14b of the communication slot 14 can be strong enough to provide additional force for holding the glucometer against the communication device. The friction between the contact surfaces also provides for good electrical contact between the connector 222 and the communication slot 14 for reliable transmission of communication signals between the mobile phone 1 and the glucometer 200.

In accordance with an embodiment of the present invention as described above, the glucometer 200 is attached to the mobile phone 1 by a combination of the body 210, the flange 220, the connector 222, and the retaining member 250. As depicted in FIG. 4a-4c, the connector 222 protrudes from the flange 220, which protrudes from the body 210. Thus, when the connector 222 is inserted into the communication slot 14 of the mobile phone 1, the combination of the body 210, the flange 220 and the connector 222 functions as a hook for holding the glucometer against the mobile phone 1. Moreover, the friction between contact surfaces 222a and 222b of the connector 222 with the contact surfaces 14a and 14b, respectively, of the communication slot 14 holds the glucometer 200 to the mobile phone 1. In addition, the force exerted by the springy material 260 on the contacting surface of mobile phone 1 and on the contacting surface of the retainer 252 will hold the mobile phone 1 in position. Thus, the mobile phone 1 remains fastened to the body 210 of the glucometer 200, between the flange 220 and the retaining member 250.

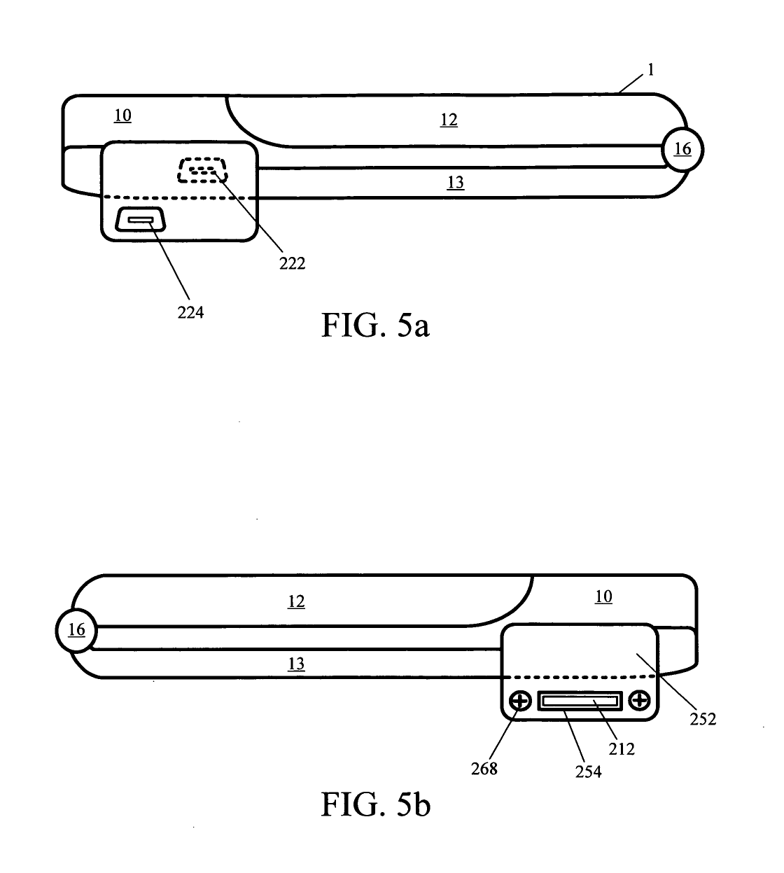

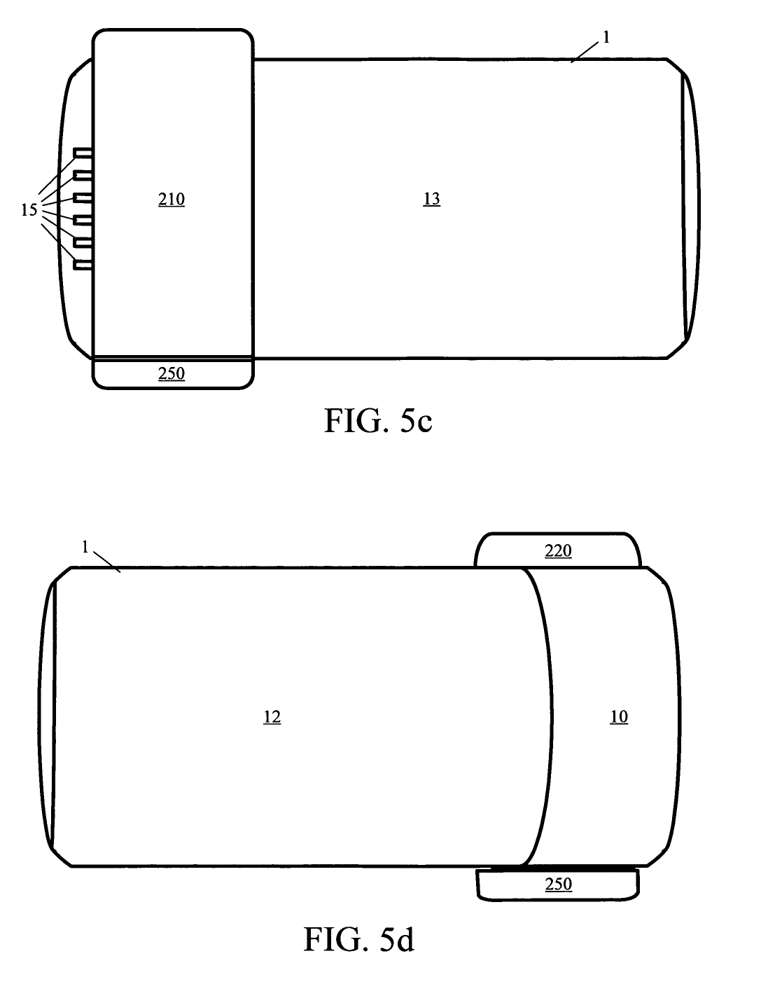

FIG. 5a is a first side view of an exemplary external glucometer affixed to the mobile phone shown in FIG. 4c. Referring to FIG. 5a, a communication port 224 may be provided on an outside surface of the flange 220. The communication port 224 can be, for example, a USB slot for attaching an external USB device to the glucometer. The communication port 224 can also be a wireless communication port, such as in infrared port, to establish connection between the glucometer and an external communication device.

FIG. 5b is a second side view of the exemplary external glucometer affixed to the mobile phone shown in FIG. 4c. Referring to FIG. 5b, the retaining member 250 can be attached to the body of the glucometer (not shown) using screws 268. Then, a test strip can be inserted through the opening 254 into the penetrable slit 212.

As shown in FIGS. 5a and 5b, the flange 220 and the retaining member 250 are dimensioned to only cover portions of the surfaces of the mobile phone 1. For example, the flange 220 and the retaining member 250 are only as tall as about half of the thickness of the mobile phone 1. More specifically, each of the flange 220 and the retaining member 250 reaches higher than an upper edge of the back 13 of the mobile phone 1, but lower than a lower edge of the flipping cover 12 of the mobile phone 1. As shown in FIG. 4c, the height of the flange 220 and the retaining member 250 may correspond to where the mobile phone 1 is widest.

FIG. 5c is a bottom view of the exemplary external glucometer affixed to the mobile phone shown in FIG. 4c. FIG. 5d is a top view of the exemplary external glucometer affixed to the mobile phone shown in FIG. 4c. As shown in FIGS. 5a-5d, the flange 220, the retaining member 250, and the body 210 are dimensioned to only cover portions of the surfaces of the mobile phone 1. For example, the flange 220, the retaining member 250, and the body 210 are only wide enough to cover a portion of the back surface 13 of the mobile phone 1, excluding contact terminals 15 accessible for recharging an internal battery (not shown) of the mobile phone 1. As shown in FIGS. 5a-5d, the glucometer assembly, including the body 210, the flange 220, and the retaining member 250, is positioned at an end of the mobile phone 1 other than the end where the folding part 12 of the phone is hingedly attached to the handset part 10 of the mobile phone through an hinge 16. Thus, the glucometer assembly, including the body 210, the flange 220, and the retaining member 250, is unobtrusively attached to the mobile phone 1 so as not to interfere with the operations of the mobile phone 1.

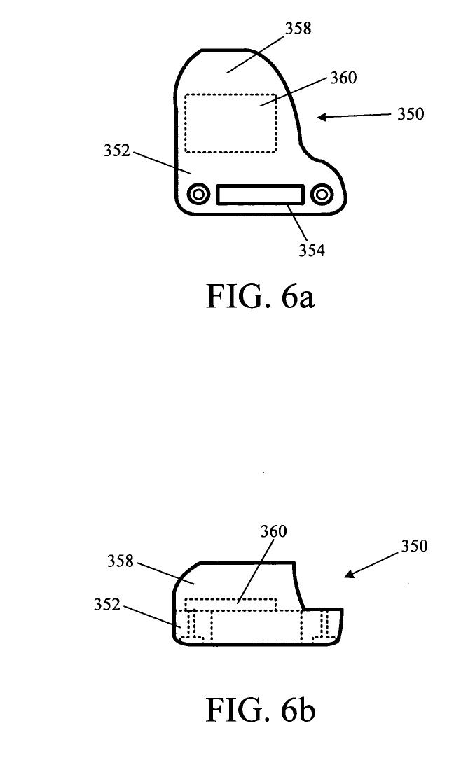

FIG. 6a is a front view of an exterior surface of an exemplary retaining member for holding a communication device against an external glucometer, in accordance with a third embodiment of the present invention. FIG. 6b is a top view of the exemplary retaining member shown in FIG. 6a. Referring to FIGS. 6a and 6b, a retaining member 350 includes a retainer 352 and a springy material 360 provided on an inside surface of the retainer 352. The retainer 352 may include fixing holes 356 for attaching the retainer member 350 to the body of an external glucometer. An opening 354 is provided through the retainer 350. The opening 352 is penetrable by a measuring strip, such as the measuring strip 230 shown in FIG. 2a.

The retainer 352 includes a retainer extension 358. The retainer extension 358 of the retainer 352 extends the height of the retainer 352 to correspond to more than a thickness of a communication device to be held against the glucometer. As shown in FIG. 6b, the upper portion of the retainer extension 358 is curved inward and extends over the springy material 360 provided on the inside surface of the retainer 352. As such, the curved upper portion of the retainer extension 358 is overarching the springy material 360.

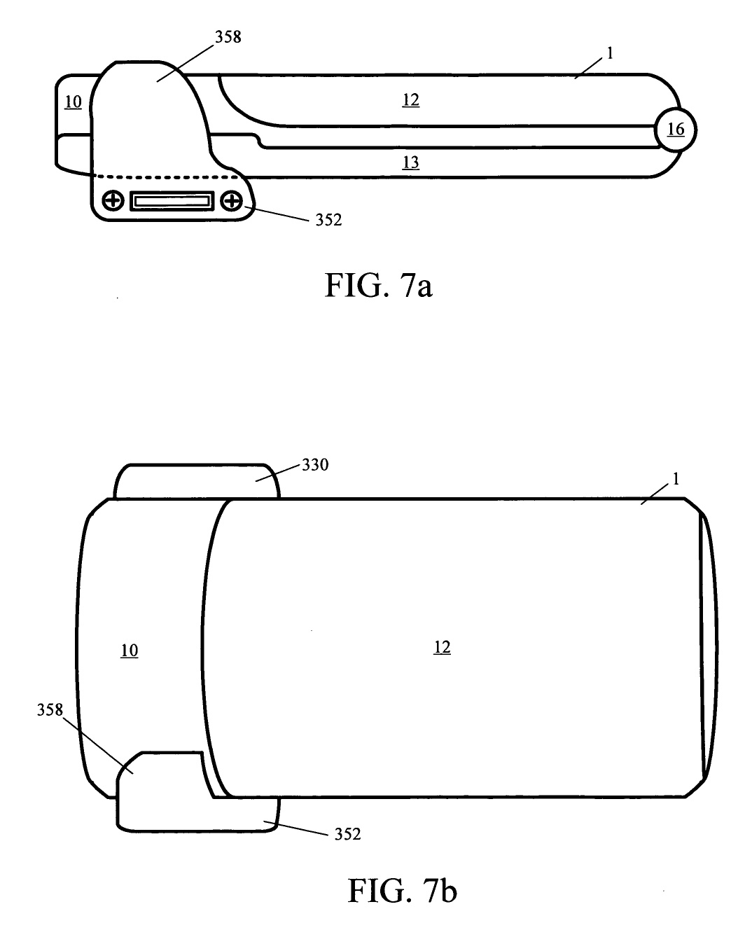

FIG. 7a is a side view of an exemplary external glucometer affixed to a mobile phone using the retaining member shown in FIGS. 6a-6b. FIG. 7b is a top view of the exemplary external glucometer affixed to the mobile phone shown in FIG. 7a. As shown in FIG. 7a, the retainer 352, including the retainer extension 358 of the retainer 352, is at least as high as the thickness of the mobile phone 1. As shown in FIG. 7b, the curved upper portion of the retainer extension 358, which overarches the spring material 360 (hidden), covers a portion of the top surface of the mobile phone 1 and extends toward the flange 330. The curved upper portion of the retainer extension 358 also overlaps a portion of the body of the glucometer under the attached mobile phone 1.

In accordance with an embodiment of the present invention as described above, the retainer 352, including the retainer extension 358, is wrapped around the side of the mobile phone 1 to cover a portion of the top surface of the mobile phone 1. Thus, the body 210 of the glucometer, the retainer 352, and the retainer extension 358 wrap around the mobile phone 1, with the body 210 of the glucometer contacting the bottom of the mobile phone 1, the retainer 352 holding the side of the mobile phone 1, and the retainer extension 358 forming a hook to maintain the mobile phone 1 against the retainer 352 and the body 210 of the glucometer. Accordingly, the mobile phone 1 is held by the body 210 of the glucometer, the retainer 352 and the retainer extension 358.

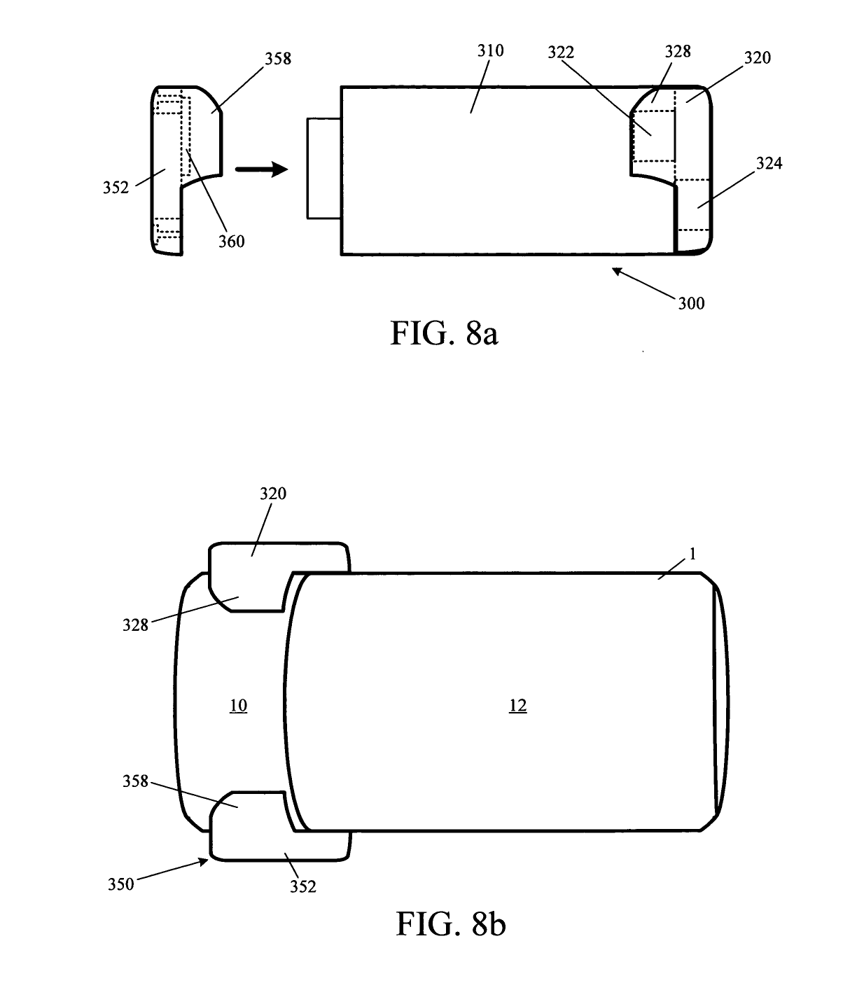

FIG. 8a is a top view of an exemplary external glucometer in accordance with a fourth embodiment of the present invention. Referring to FIG. 8a, a glucometer 300 for measuring a glucose level includes a body 310 and a flange 320 protruding from the body 310. A connector 322 protrudes from the flange 320. The protruding connector 322 is positioned on an interior surface of the flange 320. The protruding connector 322 provides a communication link, for example, a serial communication bus, such as a Universal Serial Bus (USB) for communication between the glucometer 300 and an external communication device.

A communication port 324 may be provided on an outside surface of the flange 320. The communication port 324 can be, for example, a USB slot for attaching an external USB device to the glucometer. The communication port 324 can also be a wireless communication link to establish, for example, a Bluetooth connection between the glucometer and an external communication device.

The flange 320 includes a flange extension 328. The flange extension 328 of the flange 320 extends the height of the flange 320 to more than a thickness of a communication device to be held against the glucometer. As shown in FIG. 8a, the upper portion of the flange extension 328 is curved inward and extends over the connector 322 provided on the inside surface of the flange 320. As such, the curved upper portion of the flange extension 328 is overarching the connector 322 and extends toward the retainer 352.

A retaining member 350 is provided to include a retainer 352 and a springy material 360 provided on an inside surface of the retainer 352. The retainer 352 includes a retainer extension 358. The retainer extension 358 of the retainer 352 extends the height of the retainer 352 to more than a thickness of the communication device to be held against the glucometer. As shown in FIG. 8a, the upper portion of the retainer extension 358 is curved inward extending over the springy material 360 provided on the inside surface of the retainer 352. As such, the curved upper portion of the retainer extension 358 is overarching the springy material 360.

FIG. 8b is a top view of the exemplary external glucometer of FIG. 8a affixed to a mobile phone. As shown in FIG. 8b, the curved upper portion of the retainer extension 358, which overarches the spring material 360 (hidden), covers a portion of the top surface of the mobile phone 1. The curved upper portion of the extension 358 also overlaps a portion of the body 310 of the glucometer 300 under the attached mobile phone 1. Similarly, the curved upper portion of the flange extension 328, which overarches the connector 322 (hidden), covers a portion of the top surface of the mobile phone 1. The curved upper portion of the flange extension 328 also overlaps a portion of the body 310 of the glucometer 300 under the attached mobile phone 1.

In accordance with an embodiment of the present invention as described above, the glucometer 300 is held against the mobile phone 1 by a combination of the body 310, the flange 320, the flange extension 328, the connector 322, the retainer 352, and the retainer extension 358. When the connector 322 is inserted into a communication slot of the mobile phone 1, the combination of the body 310, the flange 320, the flange extension 328 and the connector 322 functions to wrap and hook the glucometer against the mobile phone 1. Moreover, the retainer extension 358 braces the other end of the mobile phone 1 and reinforces the holding force exerted by the springy material 360. Thus, the mobile phone 1 remains fastened to the body 310 of the glucometer 300, between the flange 320 and the retaining member 350, and under the flange extension 328 and the retainer extension 358.

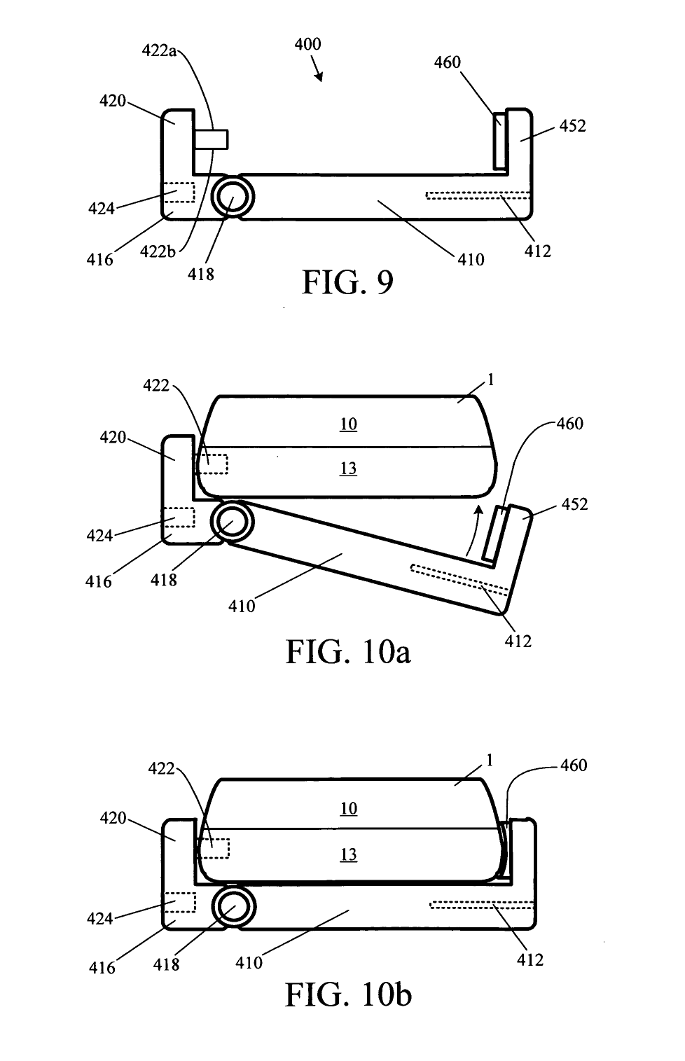

FIG. 9 is a side view of an exemplary external glucometer in accordance with a fifth embodiment of the present invention. Referring to FIG. 9, a glucometer 400 for measuring a glucose level includes a body 410, a body extension 416, a first flange 452 protruding from the body 410, and a second flange 420 protruding from the body extension 416. The body 410 is attached to the body extension 416 through a hinge 418.

The hinge 418 may incorporate a spring or a spring-like part (not shown) that tends to force the first flange 452 toward the second the flange 420. Also, the spring or spring-like part incorporated into the hinge 418 causes the hinge 418 to resist any clockwise rotation of the body 410. Thus, the spring-loaded hinge 418 opposes a pulling of the first flange 452 away from the second flange 420. The hinge 418 can also be a limited rotation hinge to allow the first flange 452 to rotate clockwise just enough to allow positioning of a communication device between the first and second flanges 452 and 420.

The first flange 452 acts as a retaining member. A springy material 460 can be provided on an inside surface of the first flange 452. A slit 412 is provided through the first flange 452. The slit 412 is penetrable by a measuring strip, such as the measuring strip 230 shown in FIG. 2a. The springy material 260 can be provided at an upper portion of the retainer 252, and the slit 412 can be provided at a lower portion of the first flange 452 to penetrate the body 410 of the glucometer 400.

The body 410 of the glucometer 400 functions as a measuring unit for measuring a glucose level in a specimen. When the measuring strip 230 is impregnated with a specimen, such as blood, and inserted into the slit 412, the specimen is analyzed within the body 410 to detect the level of glucose in the specimen.

A connector 422 protrudes from the second flange 420. The protruding connector 422 is positioned on an interior surface of the second flange 420. The protruding connector 422 is linked to the body 410 to provide, for example, a serial communication bus, such as a Universal Serial Bus (USB) for communication between the glucometer 400 and an external USB device. The hinge 418 has signal lines passing through for electrically connecting the body 410 to the connector 422.

A communication port 424 may be provided on an outside surface of the second flange 420. The communication port 424 can be, for example, a USB slot for attaching an external USB device to the glucometer 400. The communication port 424 can also be a wireless communication port, such as infrared, to establish a connection between the glucometer 400 and an external communication device.

As shown in FIG. 9, the first flange 452 can be integrally formed with the body 410. The flange first 452 also can be a separate unit permanently attached to the body 410. For example, the first flange 452 can be screwed onto the body 410. Alternatively, the first flange 452 can also be glued to the body 410.

Similarly, the second flange 420 can be integrally formed with the body extension 416. The second flange 420 also can be a separate unit permanently attached to the body extension 416. For example, the second flange 420 can be screwed onto the body extension 416. The second flange 420 can also be glued to the body extension 416.

FIGS. 10a and 10b show exemplary steps for affixing the external glucometer of FIG. 9 to a communication device. Referring to FIG. 10a, the body 410 and the first flange 452 of the glucometer 400 are rotated together clockwise to move the first flange 452 away from the second flange 420. A mobile phone 1 is positioned on an interior surface of the body 410. As shown, the body 410 of the glucometer 400 is supported on a rear surface of the mobile phone 1. A communication slot 14 of the mobile phone 1 faces the connector 222 on the interior surface of the second flange 420.

Then, as shown in FIG. 4b, the mobile phone 1 is laterally slid toward the second flange 420 of the glucometer until the connector 422 is inserted into the communication slot 14 of the mobile phone 1. The side of the mobile phone 1 where the communication slot 14 is located may contact the interior surface of the second flange 420. At the end of the sliding motion, the connector 422 is coupled with the communication slot 14 of the mobile phone.

Then, the first flange 452 and the body 410 of the glucometer 400 are returned to their original position. As shown in FIG. 10a, the combination of the first flange 452 and the body 410 rotates counterclockwise due to the force exerted by the spring loaded into the hinge 418. As shown in FIG. 10b, the springy material 460 comes into contact with the side of the mobile phone 1, and becomes compressed by the elastic force exerted by the spring loaded into the hinge 418.

The springy material 460 is used to fasten the mobile phone 1 to the glucometer 400 between the first flange 452 and the second flange 420. The springy material 460 is compressed between the side of the mobile phone 1 and the first flange 452, and exerts a force on the contacting surface of mobile phone 1, and an opposite force on the contacting surface of the first flange 452. Accordingly, the springy material 460 will hold the mobile phone 1 in position. Thus, the mobile phone 1 remains fastened to the body 410 of the glucometer 400, between the first flange 452 and the second flange 420.

In accordance with an embodiment of the present invention as described above, the glucometer 400 is held against the mobile phone 1 by a combination of the body 410, the first flange 452 including the springy material 460, the second flange 420, and the connector 422. As depicted in FIGS. 9 and 10a, the connector 422 protrudes from the second flange 420, which protrudes from the body extension 416. Thus, when the connector 422 is inserted into the communication slot 14 of the mobile phone 1, the combination of the body 410, the second flange 420 and the connector 422 functions as a hook for holding the glucometer 400 against the mobile phone 1. Moreover, the friction between contact surfaces 222a and 222b of the connector 222 with the contact surfaces 14a and 14b, respectively, of the communication slot 14 functions to hold the glucometer 400 to the mobile phone 1. In addition, the force exerted by the springy material 460 on the contacting surface of mobile phone 1 and on the contacting surface of the first flange 452 will also hold the mobile phone 1 in position. Further, the force exerted by the spring-loaded hinge 418 provides a firm grip on the sides of the mobile phone 1. Thus, the mobile phone 1 remains fastened to the body 410 of the glucometer 400, between the first flange 452 and the second flange 420.

It will be apparent to those skilled in the art that various modifications and variations can be made in the externally connected glucometer for a communication device of the present invention without departing from the spirit or scope of the invention. Thus, it is intended that the present invention cover the modifications and variations of this invention provided they come within the scope of the appended claims and their equivalents.

What is claimed is:

1. A measurement apparatus for a communication device, comprising:
a body with a measuring unit and a penetrable slit, the body extending in a first direction;
a flange protruding from the body; and
a connector protruding in the first direction from the flange for outputting a measurement data.

2. The measurement apparatus of claim 1, wherein the body is on a rear surface of a communication device and the connector is slidably coupled with a communication outlet on a first side of the communication device to hold the body against the communication device.

3. The measurement apparatus of claim 1, wherein the connector is slidably coupled with a communication outlet of a communication device to hold the body against the communication device.

4. The measurement apparatus of claim 1, further comprising a communication port for communicating with an external device.

5. The measurement apparatus of claim 1, wherein the measuring unit includes a glucometer for measuring a glucose level.

6. The measurement apparatus of claim 1, wherein the penetrable slit is provided at an end of the body and the flange is formed at an opposite end of the body.

7. A measurement apparatus for a communication device, comprising:
a body with a measuring unit and a penetrable slit;
a flange protruding from the body;
a connector protruding from the flange for outputting a measurement data; and
a retainer removably attached to the body.

8. The measurement apparatus of claim 7, wherein an opening is provided through the retainer in a matching correspondence with the slit on the body so that the retainer and the slit are jointly penetrable.

9. The measurement apparatus of claim 8, wherein the connector is slidably coupled with a communication outlet on a first side of a communication device.

10. The measurement apparatus of claim 9, further comprising an elastic material on an inside surface of the retainer.

11. The measurement apparatus of claim 10, wherein the elastic material is pressed against a second side of the communication device in a deformed state.

12. The measurement apparatus of claim 8, including a measuring strip inserted into the penetrable slit through the opening.

13. The measurement apparatus of claim 7, wherein the measuring unit includes a glucometer for measuring a glucose level.

14. The measurement apparatus of claim 7, further comprising a communication port for communicating with an external device.

15. The measurement apparatus of claim 7, wherein the retainer includes a retainer extension with an upper portion curved toward the flange.

16. The measurement apparatus of claim 15, wherein the retainer extension covers a portion of a top surface of a communication device.

17. The measurement apparatus of claim 7, wherein the flange includes a flange extension with an upper portion curved toward the retainer.

18. The measurement apparatus of claim 17, wherein the flange extension covers a portion of the top surface of the communication device.

19. The measurement apparatus of claim 18, further including a serial communication slot on a surface of the flange for connecting an external device to the body.

20. A measurement apparatus for a communication device, comprising:
a body with a measuring unit and a penetrable slit at a first end thereof;
a first flange protruding from the first end of the body;
a second flange attached to an hinge at a second end of the body; and
a connector protruding from the second flange for outputting a measurement data.

21. The measurement apparatus of claim 20, wherein the body is on a rear surface of a communication device and the connector is slidably coupled with a communication outlet on a first side of the communication device.

22. The measurement apparatus of claim 20, including a measuring strip inserted into the penetrable slit.

23. The measurement apparatus of claim 20, wherein the measuring unit includes a glucometer for measuring a glucose level.

24. The measurement apparatus of claim 20, wherein the hinge includes a spring for forcing the first flange toward the second the flange.

25. The measurement apparatus of claim 20, wherein signal lines for electrically connecting the measuring unit to the connector pass through the hinge.
